(19) United States
(12) Patent Application Publication
(10) Pub. No.: US 2006/0045190 A1
(43) Pub. Date: Mar. 2, 2006

(54) Low-complexity error concealment for real-time video decoder

(75) Inventors: Shijun Sun, Vancouver, WA (US); Jie Zhao, Vancouver, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/934,273

(22) Filed: Sep. 2, 2004

(51) Int. Cl. H04B 1/66; H04N 11/04; H04N 7/12; H04N 11/02

(52) U.S. Cl. 375/240.27; 375/240.24

(57) ABSTRACT

Errors are concealed in a decoded bitstream, such as a bitstream based on an H.264 protocol, by detecting macroblocks in the bitstream containing data errors. Each detected macroblock containing a data error is filled with prediction data. Each macroblock, whether containing no errors or containing prediction data, is then reconstructed by the same macroblock reconstruction module.

### BACKGROUND OF THE INVENTION

1. Field of the Invention

The present invention relates to data compression techniques. In particular, the present invention relates to a method for detecting and concealing errors in a compressed bitstream.

2. Description of the Related Art

Advances in video coding and communication techniques in recent years have enabled many streaming-video applications that use a compressed bitstream. A compressed bitstream can be, however, vulnerable to transmission errors. Consequently, for most video coding standards, such as H.263, MPEG-2/4, and H.264, a decoder may not be able to recover easily from an error in a bitstream of only a single bit until the next synchronization point in the bitstream. A single bit error could cause a missing block that is required as a basis for the prediction of other blocks that, in turn, are missing because they cannot be correctly reconstructed. Thus, error detection and error concealment have become particularly important for video decoding in an error-prone environment.

Error concealment processing refers to a processing technique that is applied at the decoder side of a bitstream that is used for recovering corrupted areas of a coded video and for making errors less noticeable. Conventionally, error concealment processing is done as part of post-processing after decoding a whole picture. The error blocks are concealed by “guessing” their value from nearby uncorrupted blocks in the same or previous frames based on one or more assumptions of relating to the characteristics of the video content, such as spatial and temporal smoothness.

For example, Section V of Y. Wang et al., “Error Control and Concealment for Video Communication: A Review,” Proceedings of the IEEE, Vol. 86, No. 5, May 1998, discloses a list of conventional error concealment techniques that include a maximally smooth recovery technique, a spatial and a frequency domain interpolation technique, a recovery of motion vectors technique and a coding-modes technique. Additional function/hardware modules are required for a conventional post-processing-based technique. Moreover, complexities of the conventional techniques are quite varied. That is, many of the conventional techniques are extremely complex for real time hardware implementations.

Consequently, what is needed is a low-complexity error concealment technique that requires no additional function/hardware modules. Additionally, what is needed is a low-complexity error concealment technique that is well suited for real-time H.264-type hardware decoders.

### SUMMARY OF THE INVENTION

The present invention provides a low-complexity error concealment technique that requires no additional function/hardware modules. Additionally, what is needed is a low-complexity error concealment technique that is well suited for real-time H.264-type hardware decoders.

The advantages of the present invention are provided by a method of concealing errors in a compressed bitstream, in which the bitstream is, for example, based on an H.264 protocol, contains undecoded macroblocks of data. At least one undecoded macroblock containing a data error is detected. Each undecoded macroblock detected to contain a data error is filled with prediction data. Each macroblock filled with prediction data and each macroblock containing no errors is then reconstructed by, for example, an H.264 baseline profile decoder.

In one aspect of the present invention, the macroblocks form a plurality of pictures and each macroblock has a macroblock address. Accordingly, detecting at least one undecoded macroblock containing a data error includes determining that each undecoded macroblock contains a data error from a macroblock address of a last macroblock of a picture that was correctly reconstructed plus 1 to a maximum macroblock address of the picture when the macroblock address of the last macroblock of the picture that was correctly reconstructed does not equal the maximum macroblock address of the picture.

In another aspect of the present invention, a plurality of macroblocks form a slice, and each macroblock has a macroblock address. For this aspect, detecting at least one undecoded macroblock containing a data error includes determining that each undecoded macroblock contains a data error from the macroblock address of a last macroblock that was correctly reconstructed plus 1 to the macroblock address of a first macroblock of a slice minus 1 when the macroblock address of the first macroblock of the slice is greater than the macroblock address of the last macroblock that was correctly reconstructed plus 1. When the macroblock address of the first macroblock of the slice is less than the macroblock address of the last macroblock that was correctly reconstructed plus 1, detecting at least one undecoded macroblock containing a data error includes determining that each macroblock contains a data error from the macroblock address of a last non-copy macroblock before the first macroblock of the slice that was correctly reconstructed plus 1 to the macroblock address of the first macroblock of the slice minus 1.

Filling each undecoded macroblock detected to contain a data error with prediction data can include selecting an intra fill mode for a macroblock containing a data error when the macroblock is part of an Instantaneous Decoding Refresh picture and when a first macroblock of the Instantaneous Decoding Refresh picture has been correctly reconstructed. When a vertical macroblock address is greater than 0 and when a horizontal macroblock address is greater than 0, selecting the intra fill mode for the macroblock further includes selecting the DC mode. When only a vertical macroblock address is greater than 0, selecting the intra fill mode for the macroblock further includes selecting a vertical prediction only mode. When only a horizontal macroblock address is greater than 0, selecting the intra fill mode for the macroblock further includes selecting a horizontal prediction only mode.

Filling each undecoded macroblock detected to contain a data error with prediction data can also include selecting an intra fill mode for an undecoded macroblock detected to contain a data error when the macroblock is part of an Instantaneous Decoding Refresh picture and when the Instantaneous Decoding Refresh picture is a first picture of the bitstream or when the Instantaneous Decoding Refresh picture is a first picture after a channel switching. Similarly, when a vertical macroblock address is greater than 0 and when a horizontal macroblock address is greater than 0, selecting the intra fill mode for the macroblock further includes selecting the DC mode. When only a vertical macroblock address is greater than 0, selecting the intra fill mode for the macroblock further includes selecting a vertical prediction only mode. When only a horizontal macroblock address is greater than 0, selecting the intra fill mode for the macroblock further includes selecting a horizontal prediction only mode.

When the macroblock is not part of an Instantaneous Decoding Refresh picture, filling each undecoded macroblock detected to contain a data error with prediction data includes selecting an inter fill mode for an undecoded macroblock detected to contain a data error. Similarly, when a first macroblock of a picture of which the macroblock is part has not been correctly reconstructed and when the picture is not a first picture of the bitstream or when the picture is a first picture after a channel switching, filling each undecoded macroblock detected to contain a data error with prediction data includes selecting an inter fill mode for a macroblock containing a data error.

### BRIEF DESCRIPTION OF THE DRAWINGS

The present invention is illustrated by way of example and not by limitation in the accompanying figures in which like reference numerals indicate similar elements and in which:

FIG. 1 depicts a functional block diagram of an exemplary decoder having an H.264 baseline profile;

FIGS. 2A and 2B depict a flow diagram of an exemplary technique for locating MBs that should be concealed according to the present invention; and

FIG. 3 depicts a flow diagram of an exemplary technique selecting the fill mode that is used for concealing a detected MB error according to the present invention.

### DETAILED DESCRIPTION OF THE PRESENT INVENTION

The present invention provides a low-complexity error concealment technique that requires no additional function/hardware modules and that is well suited for real-time H.264-type hardware decoders. The error concealment technique of the present invention is done “on-the-fly” during decoding rather than being a post-processing operation, as is conventionally done. Unlike conventional error concealment methods that all require special modules for predicting the missing motion vectors (MVs) and/or for reconstruction, the error concealment technique of the present invention does not require any additional modules than already exist in a conventional H.264 baseline profile decoder. That is, the present invention utilizes all of the motion vector prediction and Macroblock (MB) reconstruction modules already available for a standard video decoder. Consequently, the present invention is easily implemented for hardware decoders and real-time applications.

While the present invention will be described in terms of the baseline profile of video coding standard H.264, it should be understood that the techniques of the present invention is not so limited and the present invention can be used as part of other block-based video-coding techniques.

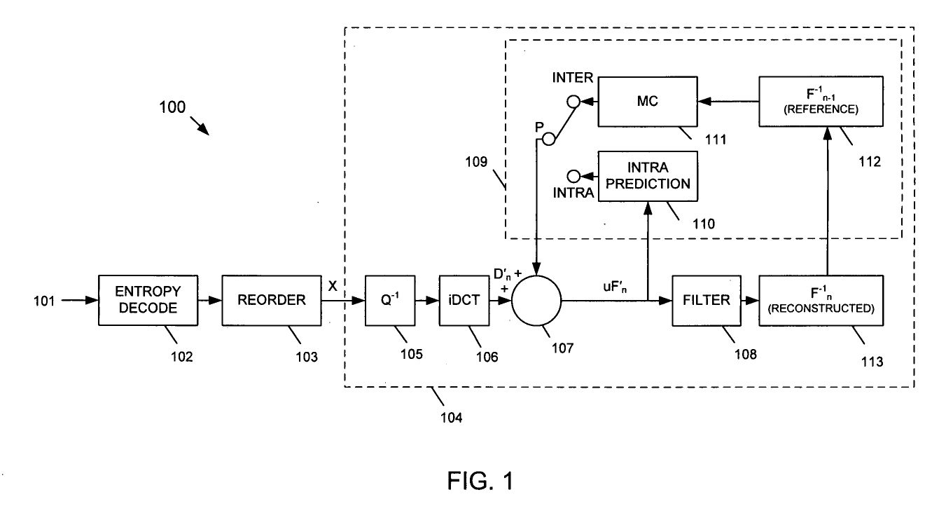

FIG. 1 depicts a functional block diagram of an exemplary decoder 100 having an H.264 baseline profile. Decoder 100 includes an entropy decoder 102, a reorderer 103 and an MB reconstruction module 104. MB Reconstruction module 104 includes a dequantizer (Q⁻¹) 105, an inverse Discrete Cosine Transformer (iDCT) 106, a summer 107, a filter 108, and an intra/inter prediction module 109. Intra/inter prediction module 109 includes intra prediction 110 and motion compensation (MC) 111 on a reference frame F⁻¹ₙ₋₁.

In FIG. 1, a compressed bitstream 101 is received by an entropy decoder 102 from the Network Abstraction Layer (NAL). Entropy decoder 102 entropy decodes bitstream 101. The entropy-decoded bitstream is reordered by reorderer 103 to produce a set of quantized coefficients X. Quantized coefficients X are rescaled at dequantizer (Q⁻¹) 105 and inverse transformed at iDCT 106 to generate D′ₙ. Header information within bitstream 101 is used to generate a prediction MB P, which is based on either intra prediction 110 or a reference frame F⁻¹ₙ₋₁ 112 that has been motion compensated (MC) at 111. Prediction MB P is added to D′ₙ to generate unfiltered MB uF′ₙ. Unfiltered MB uF′ₙ is filtered at 107 to form decoded macroblock F′ₙ 113.

In, for example, an H.264 video stream, a picture is partitioned into one or more slices, such that each slice comprises, for example, a sequence of 16×16 Macroblocks (MBs) in a raster scan order. For an H.264 video stream, there are three types of slices: an I (Intra) slice, a P (Predictive) slice, and a B (Bi-predictive) slice. A slice start code signals a resynchronization point in an H.264 video stream.

According to the present invention, error concealment (when needed) is performed at the start of each slice after decoding each new slice header. Decoder 100 processes MBs, as described below, and fills MBs detected as errors with prediction data based on the slice type and the MB location. The MB concealment process follows a conventional MB decoding order and is performed using existing MB modes by MB reconstruction module 104. For most of the MB reconstruction process, there is not a significant difference between reconstruction of a non-error MB and an MB containing prediction data. Basically, the difference is that the filter function is turned off when an MB containing is reconstructed, which is consistent with standard signaling procedure.

In order to perform error concealment, bit errors must be detected first. The decoder is capable of detecting bitstream and syntax errors when any invalid symbols are encountered. The present invention also assumes that the MB address (mba) is continuous from one slice to the next slice. By recording and monitoring the mba of the last correctly reconstructed MB number in a variable field (last_good_mba), gaps in the MB address can be found and, consequently, the MBs that should be concealed can be located.

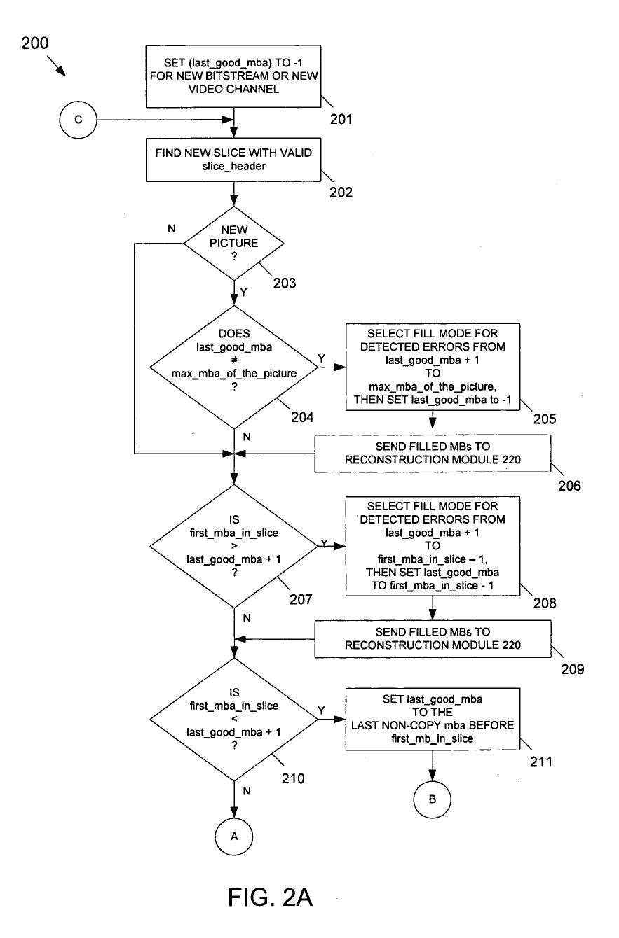

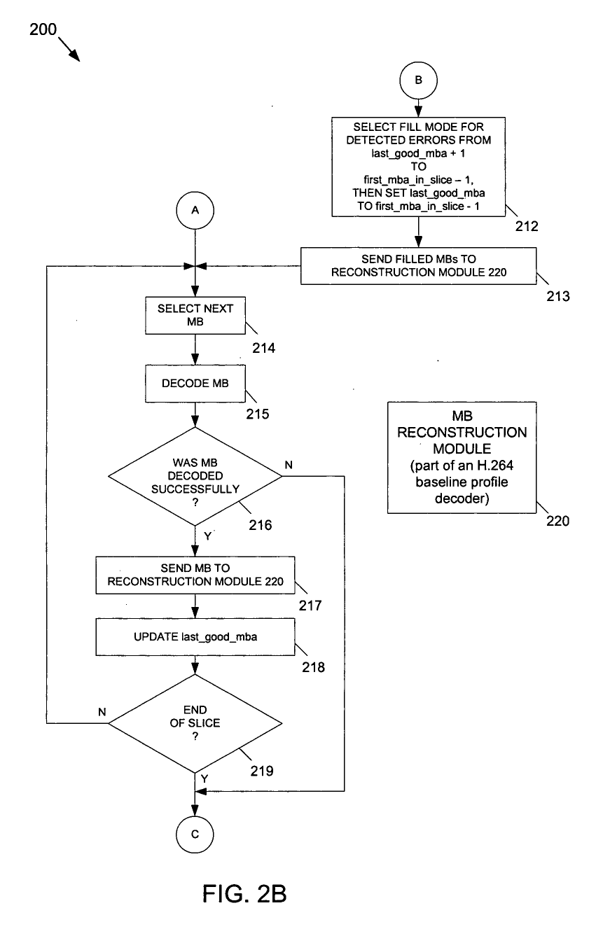

FIGS. 2A and 2B depict a flow diagram 200 of an exemplary technique for locating MBs that should be concealed according to the present invention. At step 201, the last_good_mba field is initialized to the value “−1” for the first slice header of a bitstream. This occurs for each new bitstream or for a new video channel. At step 202, a new slice is located having a valid slice_header. Flow continues to step 203, where it is determined whether the slice located having a valid slice_header is part of a new picture. If so, flow continues to step 204. If not, flow continues to step 207.

At step 204, it is determined whether the last_good_mba≠max_mba_of_the_picture. If not, flow continues to step 207. If so, flow continues to step 205 where a fill mode is selected for MB errors detected in the previous picture from last_good_mba+1 to max_mba_of_the_picture. The variable max_mba_of_the_picture can be derived from picture width and picture height. Additionally, at step 205, the last_good_mba is set to “−1”. Flow then continues to step 206 where the filled MBs are sent to MB reconstruction module 220, which is a separate module that operates separately from the technique for locating MBs that should be concealed of flow diagram 200 and is preferably part of a conventional H.264 baseline profile decoder (i.e., block 104 in FIG. 1). To emphasize the separateness of MB reconstruction module 220 from the exemplary technique of the present invention for locating MBs that should be concealed, MB reconstruction module 220 is shown as being separate in FIG. 2B. It should be understood that MB reconstruction module is not part of a post-processing operation that occurs after decoding a whole picture.

At step 207, it is determined whether first_mba_in_slice>(last_good_mba+1). If so, flow continues to step 208, where a fill mode is selected for MB errors detected from (last_good_mba+1) to (first_mba_in_slice−1). This includes situations in which decoding process stopped in the beginning or middle of previous slice because of bit errors. Additionally at step 207, the variable last_good_mba is set equal to (first_mba_in_slice−1). Flow then continues to step 209 where the filled MBs are sent to MB reconstruction 220. Flow continues to step 210.

If, at step 207, first_mba_in_slice≦(last_good_mba+1), then flow continues to step 210 where it is determined whether first_mba_in_slice≦(last_good_mba+1). If so, flow continues to step 211 because either the last_good_mba or the first_mb_in_slice is wrong. At step 211, the last_good_mba is set to the last non-copy mba that occurred before the first_mb_in_slice. One reason for flow to continue to step 211 is because the skip run for copy MBs was actually incorrect somewhere in the previous slice, thereby causing the decoding overrun into the current slice. The error, though, could not be detected because the error was a valid number. In such a situation, the last_good_mba is selected to be the mba of the last non-copy MB that occurred before the first_mb_in_slice. At this point, flow continues to step 212, where a fill mode is selected for MB errors detected from (last_good_mba+1) to (first_mba_in_slice−1). Additionally at step 212, the last_good_mba is set to the first_mba_in_slice−1. Flow continues to step 213, where the filled MBs are sent to MB reconstruction 220. Flow then continues to step 214.

If, at step 210, first_mba_in_slice=(last_good_mba+1), flow continues to step 214 where the next MB is selected. At step 215, the MB is decoded. At step 216, it is determined whether the MB was successfully decoded. If not, flow continues back to step 202 where a new slice having a valid slice_header is found, and the process continues. If, at step 216, the MB was successfully decoded, flow continues to step 217 where the successfully decoded MB is sent to MB reconstruction 220. Flow continues to step 218 where the last_good_mba is set to the mba of the last successfully decoded MB. At step 219, it is determined whether the last successfully decoded MB is the last MB of the slice. If not, flow continues back to step 214 where the next MB in the slice is selected and the process continues. If, at step 219, the last successfully decoded MB is the last MB of the slice, flow continues back to step 202 were a valid slice_header is found and the process continues.

For the missing MBs, the fill mode is selected (steps 205, 208 and 212 in FIG. 2) based on the slice type and picture type and the locations of the MB errors.

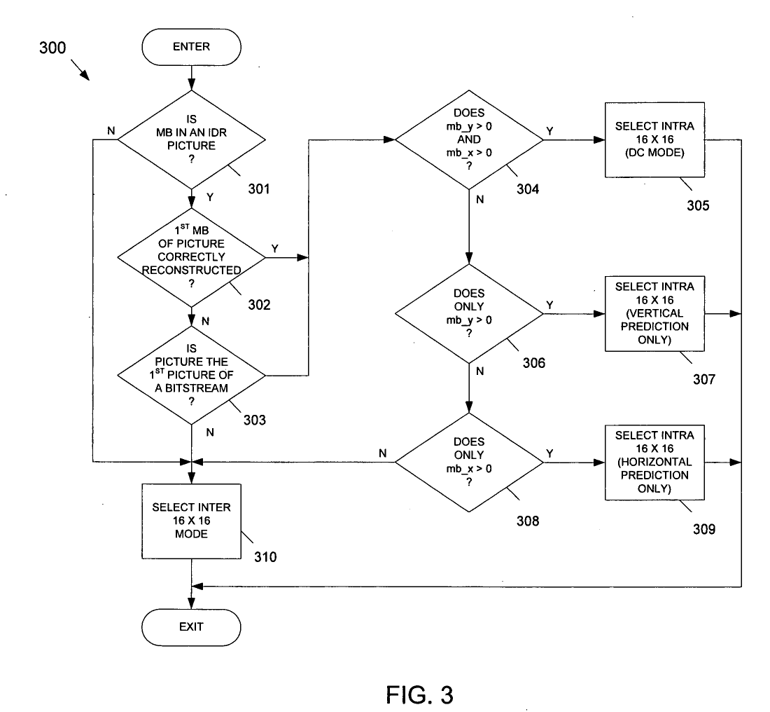

FIG. 3 depicts a flow diagram 300 of an exemplary technique selecting the fill mode that is used for concealing a detected MB error according to the present invention. At step 301, it is determined whether the picture in which the MB(s) that is(are) to be concealed are located in an IDR picture. An IDR (Instantaneous Decoding Refresh) picture is a special intra picture in the H.264 standard. All pictures decoded prior to an IDR picture will not be used as a reference picture. IDR pictures are typically used at scene changes or as random-access/error-recovery points. If, at step 301, the MB(s) that is(are) to be concealed are in an IDR picture, flow continues to step 302. If, at step 301, the MB(s) that is(are) to be concealed are not in an IDR picture, flow continues to step 310 where an inter 16×16 mode is selected as the fill mode for filling the MB(s) with prediction data. Flow then exits.

At step 302, it is determined whether the first MB of the current picture has been reconstructed correctly. If so, flow continues to step 304. If not, flow continues to step 303 where it is determined whether the current picture is the first picture of a bitstream (or the first picture after a channel switching). If so, flow continues to step 304. If not, flow continues to step 310 where an inter 16×16 mode is selected as the fill mode for filling the MB(s) with prediction data. Flow then exits.

When flow continues to step 304, it is determined whether mb_y>0 and mb_x>0. If so, flow continues to step 305 where the intra 16×16 mode (DC mode, i.e., mode 2) is selected for filling the MB(s) with prediction data. Flow then exits. If, at step 304, it is determined that mb_y≦0 or mb_x≦0, flow continues to step 306 where it is determined whether only mb_y≧0. If so, flow continues to step 307 where the intra 16×16 mode (vertical prediction only, i.e., mode 0) is selected for filling the MB(s) with prediction data. Flow then exits. If, at step 306, it is determined that mb_y<0, flow continues to step 308 where it is determined whether only mb_x>0. If so, flow continues to step 309 where the intra 16×16 mode (horizontal prediction only, i.e., mode 1) is selected for filling the MB(s) with prediction data. Flow then exits.

Table 1 shows Peak Signal-to-Noise Ratio (PSNR) performance for the error concealment technique of the present invention in contrast with a conventional post-processing error concealment technique for an H.264 baseline decoder and for two selected CIP and QVGA video sequences. In particular, each video sequence bitstream was a 384 kbps bitstream having an error rate of 10⁻⁴ bps for a 15 fps CIF video sequence and a QVGA video sequence. The PSNR values shown in Table 1 are calculated based on the original video data. As Table 1 shows, the error concealment technique of the present invention achieves performance that is very close to the performance of the conventional concealment technique, while being much easier to implement,

TABLE 1

| Error | CIP- | CIP- | QVGA- | QVGA- |
|---|---|---|---|---|
| bitstreams | 2row_per_slc_1 | 2row_per_slc_2 | 2row_per_slc | 1frm_per_slc |
| Present | 32.9003 dB | 32.7989 dB | 33.3221 dB | 28.3110 db |
| invention | | | | |
| Conventional | 32.8418 dB | 32.6685 dB | 33.1688 dB | 28.2484 dB |
| Postprocessing | | | | |

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of concealing errors in a compressed bitstream, the bitstream containing undecoded macroblocks of data, the method comprising:
detecting at least one undecoded macroblock containing a data error; and
filling each undecoded macroblock detected to contain a data error with prediction data.

2. The method according to claim 1, further comprising reconstructing each macroblock filled with prediction data and each macroblock containing no errors.

3. The method according to claim 2, wherein reconstructing each macroblock filled with prediction data is performed by an H.264 baseline profile decoder.

4. The method according to claim 1, wherein the bitstream is based on an H.264 protocol.

5. The method according to claim 1, wherein the macroblocks form a plurality of pictures and each macroblock has a macroblock address, and
wherein detecting at least one undecoded macroblock containing a data error includes determining that each undecoded macroblock contains a data error from a macroblock address of a last macroblock of a picture that was correctly reconstructed plus 1 to a maximum macroblock address of the picture when the macroblock address of the last macroblock of the picture that was correctly reconstructed does not equal the maximum macroblock address of the picture.

6. The method according to claim 1, wherein a plurality of macroblocks form a slice,
wherein each undecoded macroblock has a macroblock address, and
wherein detecting at least one undecoded macroblock containing a data error includes determining that each undecoded macroblock contains a data error from the macroblock address of a last macroblock that was correctly reconstructed plus 1 to the macroblock address of a first macroblock of a slice minus 1 when the macroblock address of the first macroblock of the slice is greater than the macroblock address of the last macroblock that was correctly reconstructed plus 1.

7. The method according to claim 1, wherein a plurality of macroblocks form a slice,
wherein each undecoded macroblock has a macroblock address, and
wherein detecting at least one undecoded macroblock containing a data error includes determining that each undecoded macroblock contains a data error from the macroblock address of a last macroblock that was correctly reconstructed plus 1 to the macroblock address of a first macroblock of a slice minus 1 when the macroblock address of the first macroblock of the slice is less than the macroblock address of the last macroblock that was correctly reconstructed plus 1.

8. The method according to claim 1, wherein filling each undecoded macroblock detected to contain a data error with prediction data includes selecting an intra fill mode for an undecoded macroblock detected to contain a data error when the macroblock is part of an Instantaneous Decoding Refresh picture and when a first macroblock of the Instantaneous Decoding Refresh picture has been correctly reconstructed.

9. The method according to claim 8, wherein selecting the intra fill mode for the macroblock further includes selecting the DC mode when a vertical macroblock address is greater than 0 and when a horizontal macroblock address is greater than 0.

10. The method according to claim 8, wherein selecting the intra fill mode for the macroblock further includes selecting a vertical prediction only mode when only a vertical macroblock address is greater than 0.

11. The method according to claim 8, wherein selecting the intra fill mode for the macroblock further includes selecting a horizontal prediction only mode when only a horizontal macroblock address is greater than 0.

12. The method according to claim 1, wherein filling each undecoded macroblock detected to contain a data error with prediction data includes selecting an intra fill mode for an undecoded macroblock detected to contain a data error when the macroblock is part of an Instantaneous Decoding Refresh picture and when the Instantaneous Decoding Refresh picture is a first picture of the bitstream.

13. The method according to claim 12, wherein selecting the intra fill mode for the macroblock further includes selecting the DC mode when a vertical macroblock address is greater than 0 and when a horizontal macroblock address is greater than 0.

14. The method according to claim 12, wherein selecting the intra fill mode for the macroblock further includes selecting a vertical prediction only mode when only a vertical macroblock address is greater than 0.

15. The method according to claim 12, wherein selecting the intra fill mode for the macroblock further includes selecting a horizontal prediction only mode when only a horizontal macroblock address is greater than 0.

16. The method according to claim 1, wherein filling each undecoded macroblock detected to contain a data error with prediction data includes selecting an intra fill mode for an undecoded macroblock detected to contain a data error when the macroblock is part of an Instantaneous Decoding Refresh picture and when the Instantaneous Decoding Refresh picture is a first picture after a channel switching.

17. The method according to claim 16, wherein selecting the intra fill mode for the macroblock further includes selecting the DC mode when a vertical macroblock address is greater than 0 and when a horizontal macroblock address is greater than 0.

18. The method according to claim 16, wherein selecting the intra fill mode for the macroblock further includes selecting a vertical prediction only mode when only a vertical macroblock address is greater than 0.

19. The method according to claim 16, wherein selecting the intra fill mode for the macroblock further includes selecting a horizontal prediction only mode when only a horizontal macroblock address is greater than 0.

20. The method according to claim 1, wherein filling each undecoded macroblock detected to contain a data error with prediction data includes selecting an inter fill mode for an undecoded macroblock detected to contain a data error when the macroblock is not part of an Instantaneous Decoding Refresh picture.

21. The method according to claim 1, wherein filling each undecoded macroblock detected to contain a data error with prediction data includes selecting an inter fill mode for an undecoded macroblock detected to contain a data error when a first macroblock of a picture of which the macroblock is part has not been correctly reconstructed and when the picture is not a first picture of the bitstream.

22. The method according to claim 1, wherein filling each undecoded macroblock detected to contain a data error with prediction data includes selecting an inter fill mode for an undecoded macroblock detected to contain a data error when a first macroblock of a picture of which the macroblock is part has not been correctly reconstructed and when the picture is not a first picture after a channel switching.
